(19) United States
(12) Patent Application Publication
(10) Pub. No.: US 2010/0066342 A1
(43) Pub. Date: Mar. 18, 2010

(54) CONTROL CIRCUIT FOR SINGLE CHIP IC

(75) Inventor: Chun-Yao Liao, Hsinchu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: HOLTEK SEMICONDUCTOR INC., Hsinchu (TW)

(21) Appl. No.: 12/266,620

(22) Filed: Nov. 7, 2008

(30) Foreign Application Priority Data
Sep. 17, 2008 (TW) 097135715

(51) Int. Cl. B23K 11/24

(52) U.S. Cl. 323/318

(57) ABSTRACT

A control circuit for a single chip IC controlled by an external power is provided. The control circuit includes a regulating circuit, an MCU and a trigger circuit. The regulating circuit is controlled by the external power and includes a regulator to be enabled to generate an internal power for an internal circuit of the single chip IC. The MCU is controlled by the internal power and generates a switch signal to disable the regulator when the internal circuit of the single chip IC is standby. The trigger circuit is controlled by the external power and generates a trigger signal to enable the regulator based on an external signal.

### FIELD OF THE INVENTION

The present invention relates to a control circuit for a single chip IC, and more particularly to a control circuit for a regulator of a single chip IC.

### BACKGROUND OF THE INVENTION

In a single chip IC, the power of the 10 interface and the power of the primary circuit are different. To solve this problem, the circuit designer usually deploys a regulator into the single chip IC to provide the power needed by the primary circuit of the chip.

A regulator is used for providing the power needed by the single chip IC. When the regulator is disabled, the single chip IC will not be able to be operated. However, if the regulator is not disabled, the regulator will keep on consuming electricity after the single chip IC enters the standby mode.

To solve the above problem, an external control circuit is used to directly enable/disable the regulator in the prior art. However, the single chip IC will be unable to enter the standby mode from the automatic control mode and will need to be provided with an additional control unit to assist. This measure will complicate the interfaces. It is also possibly necessary to incorporate an additional MCU controlled by the external power, which will increase the cost and influence the performance.

### SUMMARY OF THE INVENTION

It is therefore an object of the present invention to provide a control circuit for a single chip IC. The control function of the regulator in the single chip IC is separated into two parts: (1) when the single chip IC is about to enter the standby mode, the MCU using the output power of the regulator generates a switch signal to disable the regulator and make the regulator enter the standby mode for saving energy; and (2) when the single chip IC is about to re-enter the operation mode, a simple circuit using the external power generates a trigger signal to enable the regulator and make the regulator enter the operation mode for re-activating the internal circuit of the single chip IC.

According to the foregoing object of the present invention, a control circuit for a single chip IC controlled by an external power is provided. The control circuit includes a regulating circuit, an MCU and a trigger circuit. The regulating circuit is controlled by the external power and includes a regulator to be enabled to generate an internal power for an internal circuit of the single chip IC. The MCU is controlled by the internal power and generates a switch signal to disable the regulator when the internal circuit of the single chip IC is standby. The trigger circuit is controlled by the external power and generates a trigger signal to enable the regulator based on an external signal.

Preferably, the regulating circuit further includes a level shifter controlled by the external power and coupled to the MCU to receive the switch signal and generate a level shifting signal; and a register controlled by the external power to enable the regulator when receiving the trigger signal and to disable the regulator when receiving the level shifting signal.

Preferably, the regulating circuit further includes a level shifter controlled by the external power and coupled to the MCU to receive the switch signal and generate a level shifting signal; and an SR latch controlled by the external power to enable the regulator when receiving the trigger signal and to disable the regulator when receiving the level shifting signal.

Preferably, the regulating circuit further includes a low voltage detector controlled by the external power and coupled to the level shifter to disable the level shifter when detecting a low level of the internal power from the regulator.

The control circuit of the present invention can effectively solve the problem where the regulator keeps on consuming electricity when the single chip IC is in the standby mode. The power of the single chip IC will accordingly be saved.

The foregoing and other features and advantages of the present invention will be more clearly understood through the following descriptions with reference to the drawings, wherein:

### BRIEF DESCRIPTION OF THE DRAWINGS

FIG. 1 is a block diagram showing a control circuit for a single chip IC according to the present invention;

FIG. 2 is a block diagram showing a first embodiment of the regulating circuit according to the present invention; and

FIG. 3 is a block diagram showing a second embodiment of the regulating circuit according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

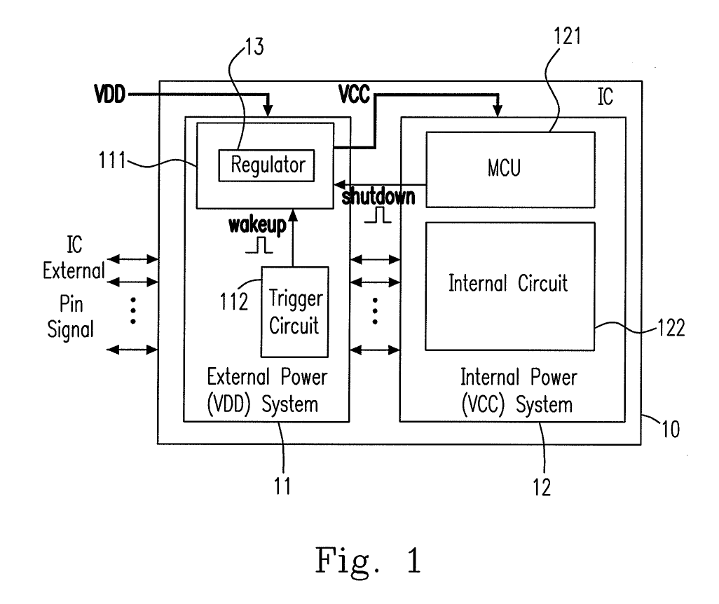

Please refer to FIG. 1, which is a block diagram showing a control circuit for a single chip IC according to the present invention. In FIG. 1, the single chip IC 10 is controlled by the external power VDD. The single chip IC 10 includes an external power system 11 controlled by the external power VDD and an internal power system 12 controlled by the internal power VCC outputted from the regulating circuit 111.

The external power system 11 includes the regulating circuit 111 and the trigger circuit 112 which are both controlled by the external power VDD. The regulating circuit 111 at least includes the regulator 13 which is similarly controlled by the external power VDD.

The internal power system 12 includes the MCU 121 and the internal circuit 122 which are both controlled by the internal power VCC.

The regulating circuit 111 is controlled by the external power VDD. When being enabled, the regulator 13 will generate the internal power VCC to provide the internal circuit 122 of the single chip IC 10 with electricity and make internal circuit 122 be in the operation mode.

When the internal circuit 122 of the single chip IC 10 is about to enter the standby mode, the MCU 121 will generate a switch signal shutdown to the regulating circuit 111 and disable the regulator 13 after each the sub-circuit in the internal circuit 122 is disabled one by one. Therefore, under the circumstance of the internal circuit 122 of the single chip IC 10 being in the standby mode, the regulator 13 is also in the standby mode and the power consumption of the system is accordingly saved.

When the internal circuit 122 of the single chip IC 10 is about to enter the operation mode, the trigger circuit 112 will generate a trigger signal wakeup based on an external signal to the regulating circuit 111 for enabling the regulator 13. The regulator 13 will generate the internal power VCC again to make the internal circuit 122 be in the operation mode.

The above-mentioned external signal not shown in the figure could be the signal of an external pin of the single chip IC 10 or the combination of some kinds of specific control signals.

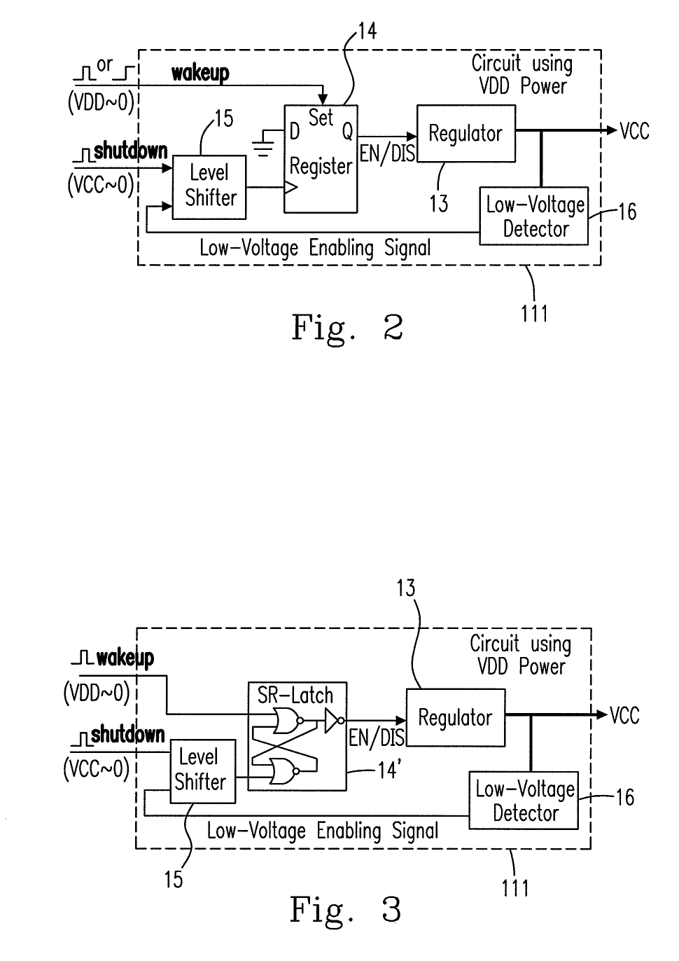

Please refer to FIG. 2, which is a block diagram showing a first embodiment of the regulating circuit according to the present invention, where the element which is the same with that in FIG. 1 is provided with the identical symbol. In FIG. 2, for matching the above trigger circuit 112 to achieve the technical feature of the present invention, the regulating circuit 11 is further provided with the register 14 and the level shifter 15 besides the regulator 13.

In FIG. 2, the regulator 13 is controlled by the high-level enable signal EN or the low-level disable signal DIS generated by the register 14. Besides, the regulator 13 can also generate the internal power VCC for providing electricity to the internal circuit 122.

When the internal circuit 122 of the single chip IC 10 is about to enter the standby mode, the MCU 121 will generate a switch signal shutdown to the regulating circuit 111 and disable the regulator 13 after each the sub-circuit in the internal circuit 122 is disabled one by one. After receiving the switch signal shutdown, the level shifter 15 generates a level shifting signal to the register 14. The register 14 then generates the low-level disable signal DIS to make the regulator enter the standby mode and the power consumption of the system is accordingly saved.

On the contrary, when the internal circuit 122 of the single chip IC 10 is about to enter the operation mode, the trigger circuit 112 will generate a trigger signal wakeup based on an external signal to the regulating circuit 111 for enabling the regulator 13. The regulator 13 then enters the operation mode and generates the internal power VCC again to make the internal circuit 122 be in the operation mode.

In FIG. 2, the regulating circuit 111 can further be provided with a low-voltage detecting circuit 16. The low-voltage detecting circuit 16 is for detecting the internal power VCC which is a voltage level changed to a ground level after the regulator 13 is disabled in the standby mode. The level shifter 15 will be disabled when the regulator 13 is in the standby mode, so as to prevent the logic circuit in the following stage from being provided with any unnecessary dc path.

Please refer to FIG. 3, which is a block diagram showing a second embodiment of the regulating circuit according to the present invention, where the element which is the same with that in FIG. 1 is provided with the identical symbol. Different from FIG. 3, the register 14 in FIG. 2 is replaced with a SR latch 14′. Therefore, only pulse wave, not square wave, is suitable for the trigger signal wakeup.

In sum, the present invention provides a control circuit for a single chip IC. When the single chip IC is about to enter the standby mode, the MCU using the output power of the regulator generates a switch signal to disable the regulator and make the regulator enter the standby mode for saving energy. When the single chip IC is about to re-enter the operation mode, a simple circuit using the external power generates a trigger signal to enable the regulator and make the regulator enter the operation mode for re-activating the internal circuit of the single chip IC.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A control circuit for a single chip IC controlled by an external power, comprising:
a regulating circuit controlled by the external power and comprising a regulator to be enabled to generate an internal power for an internal circuit of the single chip IC;
an MCU controlled by the internal power and generating a switch signal to disable the regulator when the internal circuit of the single chip IC is standby; and
a trigger circuit controlled by the external power and generating a trigger signal based on an external signal to enable the regulator.

2. A control circuit as claimed in claim 1, wherein the regulating circuit further comprises:
a level shifter controlled by the external power and coupled to the MCU for receiving the switch signal and generating a level shifting signal; and
a register controlled by the external power for enabling the regulator when receiving the trigger signal and disabling the regulator when receiving the level shifting signal.

3. A control circuit as claimed in claim 2, wherein the regulating circuit further comprises:
a low-voltage detector controlled by the external power and coupled to the level shifter for disabling the level shifter when detecting a low level of the internal power from the regulator.

4. A control circuit as claimed in claim 1, wherein the regulating circuit further comprises:
a level shifter controlled by the external power and coupled to the MCU for receiving the switch signal and generating a level shifting signal; and
an SR latch controlled by the external power for enabling the regulator when receiving the trigger signal and disabling the regulator when receiving the level shifting signal.

5. A control circuit as claimed in claim 4, wherein the regulating circuit further comprises:
a low-voltage detector controlled by the external power and coupled to the level shifter for disabling the level shifter when detecting a low level of the internal power from the regulator.
